(19) United States
(12) Patent Application Publication
(10) Pub. No.: US 2018/0134001 A1
(43) Pub. Date: May 17, 2018

(54) TWO-PLY SOLID COMPOSITE WOOD COMPONENT

(71) Applicant: SHENZHENSHI HUANWEI WOODS CO.,LTD, Shenzhen (CN)

(72) Inventor: Dawei Li, Shenzhen (CN)

(73) Assignee: SHENZHENSHI HUANWEI WOODS CO.,LTD, Shenzhen (CN)

(21) Appl. No.: 15/452,097

(22) Filed: Mar. 7, 2017

(30) Foreign Application Priority Data
Nov. 12, 2016 (CN) 201621261484.6

(51) Int. Cl. B32B 3/18; B32B 21/13; B32B 21/14; B32B 3/06; E04F 15/02; E04F 15/04

(52) U.S. Cl. CPC B32B 3/18; B32B 21/13; B32B 21/14; B32B 3/06; B32B 2419/04; E04F 15/046; B32B 2250/02; B32B 2255/08; E04F 15/02038

(57) ABSTRACT

Two-ply solid composite wood component comprises a solid wood substrate, The solid wood substrate includes two groups of horizontal grained cores, a vertical grained core and two vertical grained frames. The vertical grained core is fixed between the two groups of horizontal grained cores, such that the two groups of horizontal grained cores are supported by stress. Since the horizontal grained cores are supported by the vertical grained frames, the two groups of horizontal grained cores are not easily warped, such that the two-ply solid composite wood component has more excellent resistance to bending, deformation and warping.

### PRIORITY INFORMATION

The present application claims priority to Chinese Application No. 201621261484.6 entitled “Two-ply solid composite wood component”, filed on Nov. 12, 2016, the entire contents of which are hereby incorporated by reference.

### FIELD OF THE INVENTION

The present disclosure relates to the field of wood flooring, particularly to a two-ply solid composite wood component that can be utilized in the construction of flooring.

### BACKGROUND OF THE INVENTION

With the continuous improvement of quality of people's life, solid wood flooring is becoming more and more popular. The prior solid wood flooring can generally be classified into pure solid wood flooring made of the logs and two-ply solid composite wood components. Since the original state and real texture of a natural wood is completely retained, the pure solid wood flooring has a good appearance, a high grade, and is friendly to environment. However, the pure solid wood flooring may expand or contract due to the change of temperature and humidity of the air, thus providing bad user experience.

### SUMMARY OF THE INVENTION

In view of the deficiency of the prior art, the present disclosure provides a two-ply solid composite wood component which does not readily bend, deform or warp.

In order to achieve the above purpose, the present disclosure provides a two-ply solid composite wood component, comprising:
a solid wood substrate, including
   two groups of horizontal grained cores arranged side by side in horizontal grain direction;
   a vertical grained core fixed between the two groups of horizontal grained cores, separating the two groups of horizontal grained cores from each other;
   two vertical grained frames, being arranged on sides of the horizontal grained cores away from the vertical grained core, in grain direction of the horizontal grained core, sandwiching the two groups of horizontal grained cores and the vertical grained core in the middle, grain of the vertical grained frames and grain of the vertical grained core perpendicular to grain of the horizontal grained cores and being located in a same plane, the vertical grained frame on each side comprising two vertical grained planks, one of which is arranged between the horizontal grained cores and the other vertical grained plank; and
a solid wood panel adhered to the solid wood substrate.

The vertical grained core comprises two vertical grained supporting planks, one of which is fixed between the horizontal grained cores and the other vertical grained supporting plank.

The vertical grained core has a width in a range of 1 cm to 4 cm.

The vertical grained supporting plank has a width in a range of 0.5 cm to 2 cm.

The vertical grained frame on each side has a width in a range of 1 cm to 4 cm.

The vertical grained plank has a width in a range of 0.5 cm to 2 cm.

The horizontal grained cores consist of a plurality of horizontal grained strips glued together, each of which has a width in a range of 1 cm to 4 cm.

The two-ply solid composite wood component has a thickness in a range of 0.5 cm to 3 cm.

The vertical grained core and the two groups of horizontal grained cores are assembled together by means of a toothless binder, a micro mortise-tenon connection, a bolted joint, a finger joint or a tongue-and-groove joint, and the vertical grained core is clamped between the two groups of the horizontal grained cores.

A tongue-and-groove joint is provided around the outer periphery of the two-ply solid composite wood component, the tongued-and-grooved joint matching with another tongue-and-groove joint of another wood component.

The present disclosure provides two-ply solid composite wood component. A vertical grained core is fixed between two groups of horizontal grained cores, such that the two groups of horizontal grained cores are supported by stress. Further, since the horizontal grained cores are supported by vertical grained frames, the two groups of horizontal grained cores are not easily warped, such that the two-ply solid composite wood component has more excellent resistance to bending, deformation and warping.

### BRIEF DESCRIPTION OF THE DRAWINGS

The preferred embodiments of the present disclosure will now be described with reference to the accompanying drawings in which

FIG. 1 is a schematic diagram of the two-ply solid composite wood component provided by the present disclosure;

FIG. 2 is a cross-sectional view of the two-ply solid composite wood component as shown in FIG. 1.

### DETAILED DESCRIPTION OF ILLUSTRATED EMBODIMENTS

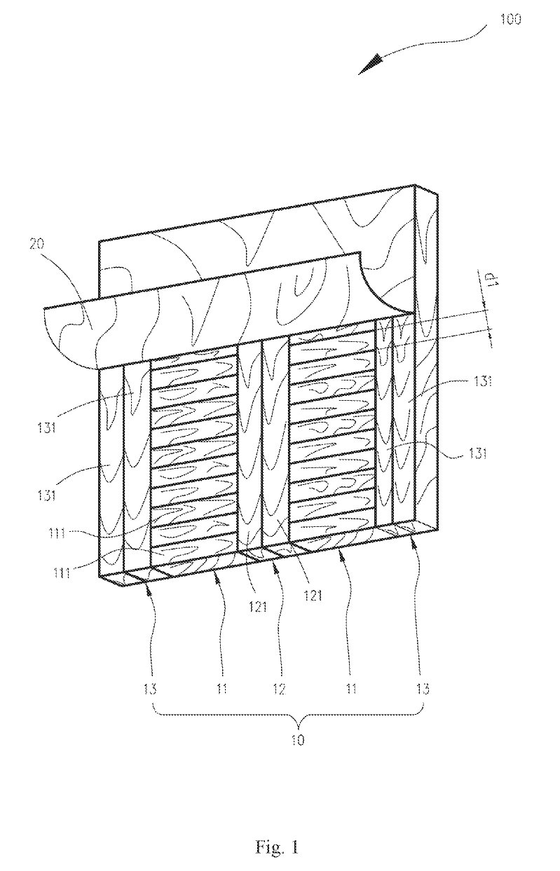

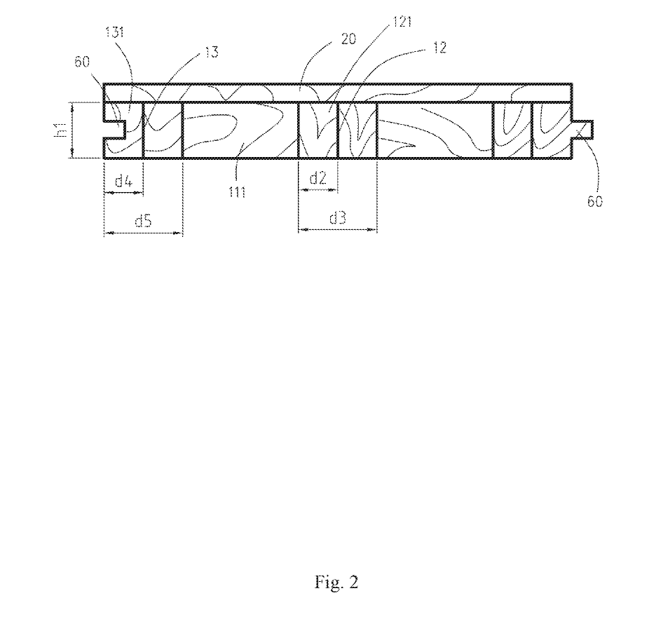

Referring to FIGS. 1 and 2, the present disclosure provides a two-ply solid composite wood component 100. The two-ply solid composite wood component 100 comprises a solid wood substrate 10 and a solid wood panel 20 adhered to the solid wood substrate 10. The solid wood substrate includes two groups of horizontal grained cores 11, a vertical grained core 12 and two vertical grained frames 13. The two groups of horizontal grained cores 11 are arranged side by side in the horizontal grain direction. The vertical grained core 12 is fixed between the two groups of horizontal grained cores 11, separating the two groups of horizontal grained cores 11 from each other. The two vertical grained frames 13 are arranged on sides of the horizontal grained cores 11 away from the vertical grained core 12 respectively, in the grain direction of the horizontal grained cores 11, sandwiching the two groups of horizontal grained cores 11 and the vertical grained core 12 in the middle. The grain of the vertical grained frames 13 and the grain of vertical grained core 12 are perpendicular to the grain of the horizontal grained cores 11 and are located in a same plane. The vertical grained frame 13 on each side comprises two vertical grained planks 131, one of which is arranged between the horizontal grained core 11 and the other vertical grained plank 131. It should be understood that a plurality of the two-ply solid composite wood component 100 may be jointed to each other for being laid on the ground. Each two-ply solid composite wood component 100 serves as the smallest unit, which facilitates transporting and storing, and has a stable structure.

The vertical grained core 12 is fixed between the two groups of horizontal grained cores 11, such that the two groups of horizontal grained cores 11 are supported by stress. Furthermore, since the two groups of horizontal grained cores 11 are supported by the vertical grained frames 13, the two groups of horizontal grained cores 11 are not easily warped, such that the two-ply solid composite wood component 100 has more excellent resistance to bending, deformation and warping.

In this embodiment, the horizontal grained cores 11 consist of a plurality of horizontal grained strips 111 glued together, each of which has a width dl in a range of 1 cm to 4 cm, including lcm and 4 cm. The horizontal grained strips 111 have a thickness h1. The plurality of horizontal grained strips 111 are arranged side by side in the vertical grain direction. The grain directions of the plurality of horizontal grained strips 111 are parallel to each other and are located in a same plane. The horizontal grained strips 111 are formed by cutting and drying a wood board. Each of the horizontal grained strips 111 is fixed at the ends in its length direction, and is connected with the vertical grained frames 13 and the vertical grained core 12. The horizontal grained strips 111 may have a same or different width. In another embodiment, the plurality of horizontal grained strips 111 can be fixed together by clamping.

In this embodiment, the vertical grained core 12 comprises two vertical grained supporting planks 121, one of which is fixed between the horizontal grained cores 11 and the other vertical grained supporting plank 121. The vertical grained supporting plank 121 can be manufactured by a same method as that of the horizontal grained strips 111. The thickness of the vertical grained supporting plank 121 is the same as the thickness h1 of the horizontal grained strips 111. That is, the thickness of the vertical grained core 12 is the same as that of the horizontal grained cores 11. The width direction of the vertical grained supporting plank 121 is parallel to the length direction of the horizontal grained strips 111. The width d2 of the vertical grained supporting planks 121 is in a range of 0.5 cm to 2 cm, including 0.5 cm and 2 cm. The width d3 of the vertical grained core 12 consisting of two vertical grained supporting planks 121 is in a range of lcm to 4 cm, including 1 cm and 4 cm. The two vertical grained supporting planks 121 may have a same or different width. For example, one of the vertical grained supporting planks 121 has a width of 0.5 cm, and the other may have a width of 2 cm. It is also possible that each of the vertical grained supporting planks 121 has a same width of 0.5 cm or 1 cm or 1.5 cm or 2 cm. It is also possible that one of the vertical grained supporting planks 121 has a width of 0.5 cm and the other may have a width of 1.5 cm. It is also possible that one of the vertical grained supporting planks 121 has a width of 1 cm, and the other may have a width of 2 cm. It is also possible that one of the vertical grained supporting planks 121 has a width of 1.5 cm, and the other may have a width of 2 cm. It is also possible that one of the vertical grained supporting planks 121 has a width of 1 cm and the other may have a width of 1.0 cm. In another embodiment, the vertical grained core 12 consists of three or four or five vertical grained supporting planks 121 glued side by side in the width direction. The number of the vertical grained supporting planks 121 included in the vertical grained core 12 is not limited.

In this embodiment, the vertical grained frames 13 can be manufactured by a same method as that of the vertical grained core 12. The vertical grained frames 13 on two sides may have a same or different width. The vertical grained planks 131 constituting the vertical grained frames 13 may have a same or different width. The vertical grained core 12 may have a width same as or different from the vertical grained frames 13. The thickness of the vertical grained planks 131 is the same as that of the horizontal grained strips 111. That is, the thickness of the vertical grained frames 13 is the same as that of the horizontal grained cores 11. The length direction of the vertical grained frames 13 is parallel to the vertical grained core 12. The width direction of the vertical grained frames 13 is parallel to the length direction of the horizontal grained strips 111. The width d4 of the vertical grained frames 13 is in a range of 1 cm to 4 cm, including 1 cm and 4 cm. The width d5 of the vertical grained planks 131 is in a range of 0.5 cm to 2 cm, including 0.5 cm and 2 cm. For example, one of the vertical grained frames 13 has a width of 2 cm and the other may have a width of 4 cm, and the corresponding vertical grained planks 131 constituting the vertical grained frames 13 have a width of 1 cm and 2 cm, respectively. It is also possible that one of the vertical grained frames 13 has a width of 2 cm and the other may have a width of 2 cm, and the corresponding vertical grained planks 131 constituting the vertical grained frames 13 have a width of 1 cm and 0.5 cm, respectively. It is also possible that one of the vertical grained frames 13 has a width of 2 cm and the other may have a width of 2 cm, and the corresponding vertical grained planks 131 constituting the vertical grained frames 13 have a width of 1 cm and 1 cm, respectively.

Furthermore, the thickness H of the two-ply solid composite wood component 100 is in a range of 0.5 cm to 3 cm, including 0.5 cm and 3 cm. Because the horizontal grained cores 11, the vertical grained core 12 and the vertical grained frames 13 have a same thickness, the thickness hi of the horizontal grained cores 11 is also the thickness of the vertical grained core 12, the vertical grained frames 13, and the solid wood substrate 10. The thickness H of the two-ply solid composite wood component 100 is a sum of the thickness of the solid wood substrate 10 and that of the solid wood panel 20. The solid wood panel 20 is adhered to a surface of the solid wood substrate 10 by an adhesive. The solid wood panel 20 completely covers and is pressed against the horizontal grained cores 11, the vertical grained core 12, and the vertical grained frames 13, forming the two-ply solid composite wood component 100.

Furthermore, the vertical grained core 12 and the two groups of horizontal grained cores 11 are assembled together by means of a toothless binder, a micro mortise-tenon connection, a bolted joint, a finger joint, or a tongue-and-groove joint; the vertical grained core 12 is clamped between the two groups of the horizontal grained cores 11. The vertical grained core 12 is secured between the two groups of horizontal grained cores 11, shortening the length of the horizontal grained strips 111, so that the horizontal grained strips 111 do not readily bend and increases the strength of the two-ply solid composite wood component 100. In addition, the vertical grained frames 13 are assembled with the horizontal grained cores 11 by means of a toothless binder, a micro mortise-tenon connection, a bolted joint, a finger joint, or a tongue-and-groove joint, clamping the two groups of horizontal grained cores 11 and the vertical grained core 12 in the middle, so the stable structure of the two-ply solid composite wood component 100 is enhanced.

Furthermore, a tongue-and-groove joint 60 is provided around the outer periphery of the two-ply solid composite wood component 100. The tongued-and-grooved joint 60 matches with another tongue-and-groove joint 60 of another two-ply solid composite wood component 100. Due to the tongue-and-groove joint 60 provided around the outer periphery of the two-ply solid composite wood component 100, it is easy to join a plurality of the two-ply solid composite wood component 100 together for being laid on the ground, with an indeformable and improved pressure-resistant property.

The present disclosure provides two-ply solid composite wood component. A vertical grained core is fixed between two groups of horizontal grained cores, such that the two groups of horizontal grained cores are supported by stress. Furthermore, since the horizontal grained cores are supported by vertical grained frames, the two groups of horizontal grained cores are not easily warped, such that the two-ply solid composite wood component has more excellent resistance to bending, deformation and warping.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A two-ply solid composite wood component, comprising:
a solid wood substrate_{;} including
two groups of horizontal grained cores arranged side by side in horizontal grain direction;
a vertical grained core fixed between the two groups of horizontal grained cores, separating the two groups of horizontal grained cores from each other;
two vertical grained frames, being arranged on sides of the horizontal grained cores away from the vertical grained core, in grain direction of the horizontal grained core, sandwiching the two groups of horizontal grained cores and the vertical grained core in the middle, grain of the vertical grained frames and grain of the vertical grained core perpendicular to grain of the horizontal grained cores and being located in a same plane, the vertical grained frame on each side comprising two vertical grained planks, one of which is arranged between the horizontal grained cores and the other vertical grained plank; and
a solid wood panel adhered to the solid wood substrate.

2. The two-ply solid composite wood component according to claim 1, wherein the vertical grained core comprises two vertical grained supporting planks, one of which is fixed between the horizontal grained cores and the other vertical grained supporting plank.

3. The two-ply solid composite wood component according to claim 2, wherein a width of the vertical grained core is in a range of 1 cm to 4 cm.

4. The two-ply solid composite wood component according to claim 2, wherein a width of the vertical grained supporting plank is in a range of 0.5 cm to 2 cm.

5. The two-ply solid composite wood component according to claim 1, wherein a width of the vertical grained frame on each side is in a range of 1 cm to 4 cm.

6. The two-ply solid composite wood component according to claim 1, wherein a width of the vertical grained plank is in a range of 0.5 cm to 2 cm.

7. The two-ply solid composite wood component according to claim 1, wherein the horizontal grained cores consist of a plurality of horizontal grained strips glued together, each of the horizontal grained strips having a width in a range of 1 cm to 4 cm.

8. The two-ply solid composite wood component according to claim 1, having a thickness in a range of 0.5 cm to 3 cm.

9. The two-ply solid composite wood component according to claim 1, wherein the vertical grained core and the two groups of horizontal grained cores are assembled together by means of a toothless binder, a micro mortise-tenon connection, a bolted joint, a finger joint, or a tongue-and-groove joint, the vertical grained core being clamped between the two groups of the horizontal grained cores.

10. The two-ply solid composite wood component according to claim 1, wherein a tongue-and-groove joint is provided around the outer periphery of the two-ply solid composite wood component, the tongued-and-grooved joint matching with another tongue-and-groove joint of another two-ply solid composite wood component.
